(19) United States
(12) Patent Application Publication
(10) Pub. No.: US 2024/0349742 A1
(43) Pub. Date: Oct. 24, 2024

(54) BANANA LEAF PRESERVATION PROCESS

(71) Applicant: AGRO VELAZQUEZ PRODUCE S.P.R. DE R.L., Veracruz (MX)

(72) Inventors: Juan Carlos VELAZQUEZ FEITO, Veracruz (MX); Diego Armando LOPEZ PALE, Veracruz (MX)

(73) Assignee: AGRO VELAZQUEZ PRODUCE S.P.R. DE R.L., Veracruz (MX)

(21) Appl. No.: 18/644,190

(22) Filed: Apr. 24, 2024

Related U.S. Application Data
(60) Provisional application No. 63/461,389, filed on Apr. 24, 2023.

(51) Int. Cl. A23B 7/04; A23B 7/005; A23B 7/153; B65B 55/14

(52) U.S. Cl. CPC A23B 7/0441; A23B 7/005; A23B 7/153; B65B 55/14

(57) ABSTRACT

A process of freezing banana leaves that preserves their appearance, quality, and freshness without compromising their safety. The process has been developed to facilitate the freezing of the banana leaf without altering its composition and making it resistant to transportation without damaging the quality of the food. The process represents a significant step in preserving food safely and efficiently.

### CROSS REFERENCE TO RELATED APPLICATION

This application claims the benefit of priority to U.S. Provisional Application No. 63/461,389 filed Apr. 24, 2023, the contents of which are incorporated herein by reference.

### TECHNICAL FIELD

The present invention belongs to the field of food, particularly it refers to the field of food preservation and even more specifically to the field of conservation by applying low temperatures for the conservation of banana leaves.

### BACKGROUND OF THE INVENTION

It is known that banana or plantain leaves are a part of the banana or plantain tree (Musa spp.), which are used in diverse cultures around the world, especially in tropical areas. This is because they are large, flexible, resistant, waterproof, and decorative leaves. These leaves are used for various culinary preparations, such as güirila, hallacas, otak-otak, sadhya or tamales, as well as, although to a lesser extent, for decorative elements and the production of clothing, ribbons, ropes, etc. So, these materials are valuable for many local crafts, as well as for informal construction, for making roofs and fences. In the agricultural field, banana leaves are used to produce mulch and substrate, as well as to package fruits and vegetables. In general, banana or plantain leaves offer a variety of uses that are used in different areas of the world.

In the food field, these leaves are a valuable material for the preparation of food, therefore, they are highly appreciated in the agricultural and food field to produce food, as well as for their packaging and even the packaging of fruits and vegetables. This makes them an essential element for human life in many parts of the world.

Banana leaves contain calcium, sulfur, iron, potassium, phosphorus, sodium, carotene, citric acid, and vitamins A, B1, B2, B6, C, which help, among other things, to reduce glucose and cholesterol levels in the blood.

Banana leaf conservation processes traditionally consist of framing, drying, dehydration and embalming. 1. Framing: It is the first step to preserve a banana leaf. The process involves placing the sheet in a frame and securing it with some staples. This allows the banana leaf to stay flat and securely in place, as well as prevent it from being thrown away. 2. Drying: This step is necessary to prevent the leaves from rotting. It is recommended to leave the leaves outdoors for several days until they are completely dry. 3. Dehydration: To prevent rot, a dehydration process is conducted. This involves placing the leaf in a container with silica sand to absorb moisture. 4. Embalming: To protect the leaf from sunlight and moisture, it is recommended to place it in an airtight container filled with mineral oil. This will prevent the blade from drying out and becoming damaged (see FIG. 1).

In addition to packaging processes, cooling or freezing processes are also considered for conservation, where these fundamentally consist of the use of freezers or cold rooms to maintain the temperature at an adequate level. These processes are widely used to preserve banana leaves that are overly sensitive to temperature or have a high moisture content and where it is desired that they remain fresh for longer.

So, one way to preserve banana leaves is by applying a temperature relatively below zero Celsius with the intention of preserving the properties of the leaf for a longer time. However, this has the following disadvantages:

The person skilled in the art knows a series of specific optimal freezing temperatures, and in particular freezing times for the banana leaf so that he can choose a suitable temperature to provide the desired temporary effect with the understanding that the banana leaf will be stored for a short time and, therefore, preferably also consider adjusting other influencing factors, including time and stacking, however it still has problems for preservation for long periods of time and even more so for transportation of the banana leaf by land or air routes where the cargo is subjected to forces that could damage it.

One of the main problems with freezing a banana leaf is that it causes damage to the appearance of the leaf since, when freezing the banana leaf, it can suffer damage to its appearance due to freezing. This damage can include dehydration, shrinkage, discoloration, and decay of leaf texture. Also, damage is caused to the structure of the leaf especially in the upper part, apex, underside, vein, and lamina of the leaf since, due to dehydration, decomposition, and stacking during freezing.

When freezing a banana leaf, the nutrients present in it can be destroyed by the cold. This can include the degradation of organic nutrients, the loss of vitamins, and the reduction of metabolic activity; on the other hand, cold can cause the growth of pathogenic organisms, such as fungi and bacteria. This can affect the health of the banana leaf and reduce its productivity.

Another problem is that the conservation process is inadequate and leads to a loss of flavor and texture. When freezing a banana leaf, the flavor and texture of it may be affected. Freezing can cause a loss of flavor, a less crispy texture, and a less attractive appearance. Additionally, there may be changes in the texture of the food: When freezing a banana leaf, the foods made from it may be affected. This may include a reduction in flavor, a less crunchy texture, and a less attractive appearance.

### SUMMARY OF THE INVENTION

It is an object of the present invention to solve the problems referred to above.

A process to preserve Musa spp leaves, which includes the following steps:

Roast banana leaves, by exposing the leaf to a temperature between 280° C. to 320° C. for 0.5 to 1.0 second; (b) Devein the banana leaf, by identifying the main vein of the leaf and making a cut, on both sides of the vein, along it, until the blades of the banana leaf are freed; (c) Eliminate foreign matter and/or microorganisms, as well as the parts of the leaf that present any undesirable defects in texture, color, or deformations of the leaf, and then wash the leaves with a soapy water solution, subsequently the leaf is immersed in a disinfectant for a period of between 5 and 10 minutes; (d) Cut and weigh the banana leaf into fragments or section of desired size; and weigh to obtain a desired weight amount; (e) Packaging the banana leaves in barrier media to contain them; and (f) Freeze the packaged banana leaf at an average temperature of −18° C. until use.

### BRIEF DESCRIPTION OF THE FIGURES

FIG. 1 shows a flow diagram of the banana leaf freezing process that is the object of the present invention;

FIGS. 2 show various photographs of the evidence of banana leaf processing in a) the banana leaf plots and in b) and c) the banana leaf harvest;

FIGS. 3 show various photographs of banana leaves; and

FIG. 5 shows a graph of the banana leaf appearance analysis.

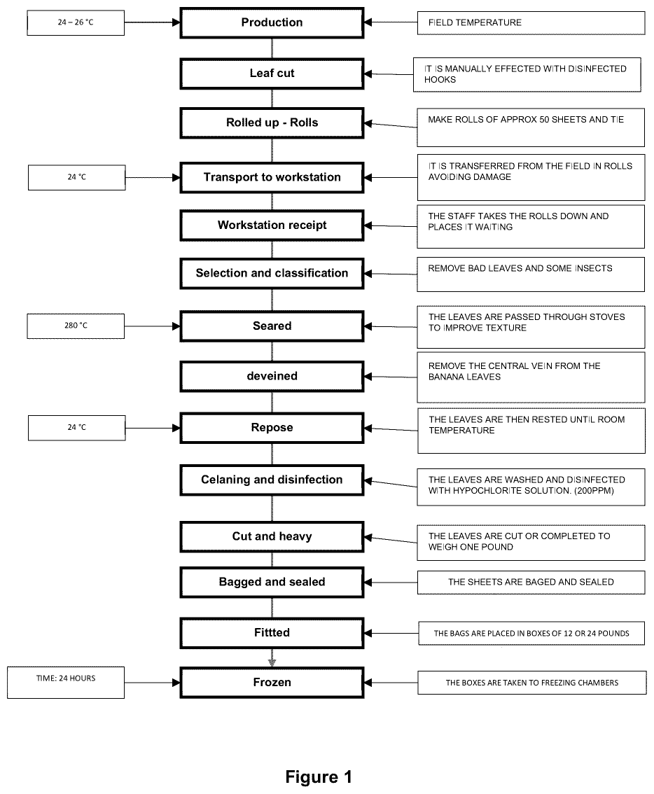

### DESCRIPTION OF THE INVENTION

The present invention refers to a process for freezing plant material, preferably banana leaves (Musa spp), which deals with an efficient process for freezing banana leaves. This invention represents a significant advance in the field of food freezing, offering a safer and more reliable method of preserving food at extremely low temperatures. The process allows the quality and freshness of the frozen banana leaves to be maintained at the same time. This invention has been specifically designed to provide consumers with a quality product that they can count on at all times.

The banana leaf has particular characteristics that prevent or greatly hinder its freezing, mainly due to its high-water content. For example, some of the disadvantages that occur are that there are important alterations in the color of the banana leaf, rigidity, in addition, lesions or burns occur on the edges of the leaves (cellular necrosis), in this sense the severity of lesions in plant tissue depends strongly on the intensity and duration of temperature. The present invention is based on a process that allows banana leaves to be frozen without losing their quality or nutritional properties. The process includes steps such as washing, cutting, cooling, rapid cooling, freezing and storage. These stages are conducted safely and efficiently, guaranteeing the best result. Additionally, it is desirable to have a frozen banana leaf for transportation procedures, since this would allow people distributed in various parts of the world to be fed without losing the quality of the food.

This invention allows banana leaf producers to offer a higher quality and fresher product to consumers, without ever compromising the safety and quality of the food. It is known that, during the transportation of banana leaves, it is exposed to external loads and forces that can damage it to a greater or lesser extent, but that said incidence can be minimized with the use of the present invention. This will reduce damage to food during transportation, improving its quality and freshness when it reaches its destination.

This invention is based on the use of a freezing method that allows a food product to be frozen safely and quickly, without generating damage that affects its properties or losing its nutritional properties or its taste quality, and also allows appropriately preserving the appearance of the product., such as color, brilliance, and flexibility, to then be marketed with quality and safety. This invention discloses a process, which in turn combines various stages, which include the use of rapid freezing equipment, a controlled freezing process, a food formulation that guarantees the nutritional stability of the frozen product and a series of control tests to ensure the safety and quality of the frozen product. Freezing equipment allows extremely low temperatures to be reached that allow food to be frozen safely in a brief period of time. This freezing must be controlled to ensure that the frozen food product retains its nutritional properties, sensory quality, appearance, and structure. On the other hand, food formulation is conducted to guarantee the nutritional stability of the frozen product, with the aim of ensuring that the product does not lose its nutritional properties during the freezing process.

Finally, a series of quality control tests are performed to ensure that the frozen product contains the required safety and quality standards. These tests include microbiological, physical, and chemical tests. Additionally, stability tests are performed to determine the length of shelf life of the frozen product.

The present invention precedes the analysis of quality parameters in the field, as well as the application of different post-harvest techniques conducted in the laboratory and statistically analyzed to define technical parameters that preserve the physical quality characteristics, as well as the relevant certifications, to market the frozen product.

An embodiment of the present invention is described below, that is, the banana leaf freezing process of the present invention consists of the following steps:

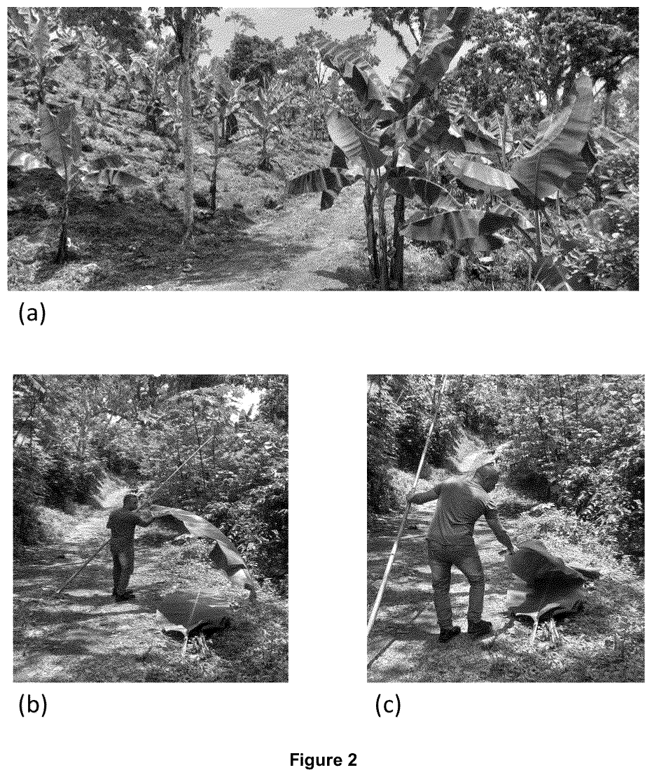

(a) Cut or section the banana leaf from the petiole of a banana plant with the use of a cutting device where the cut is made at an angle of between 45° and 65° with respect to the central axis of the petiole (FIG. 2).

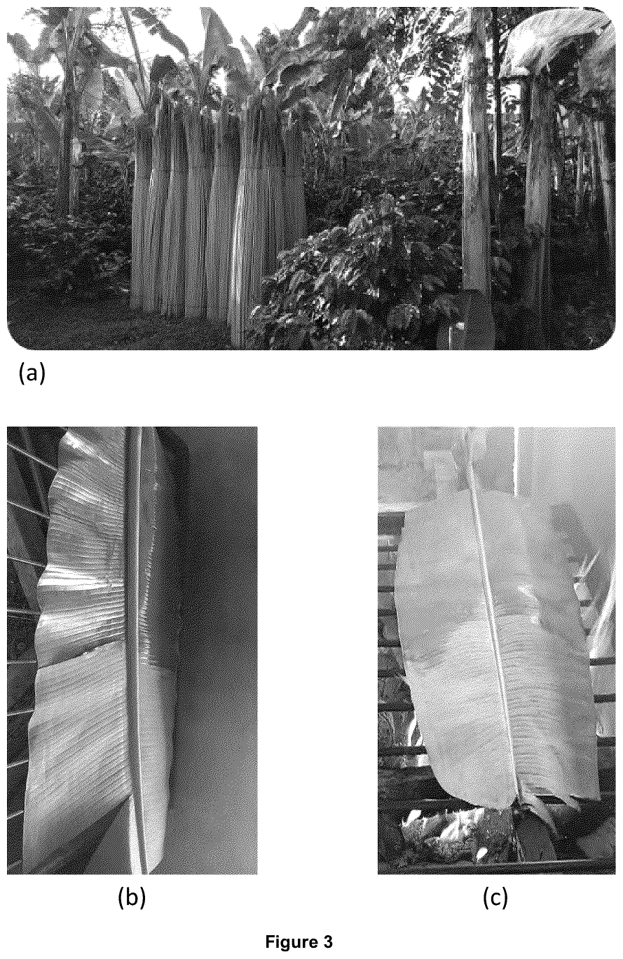

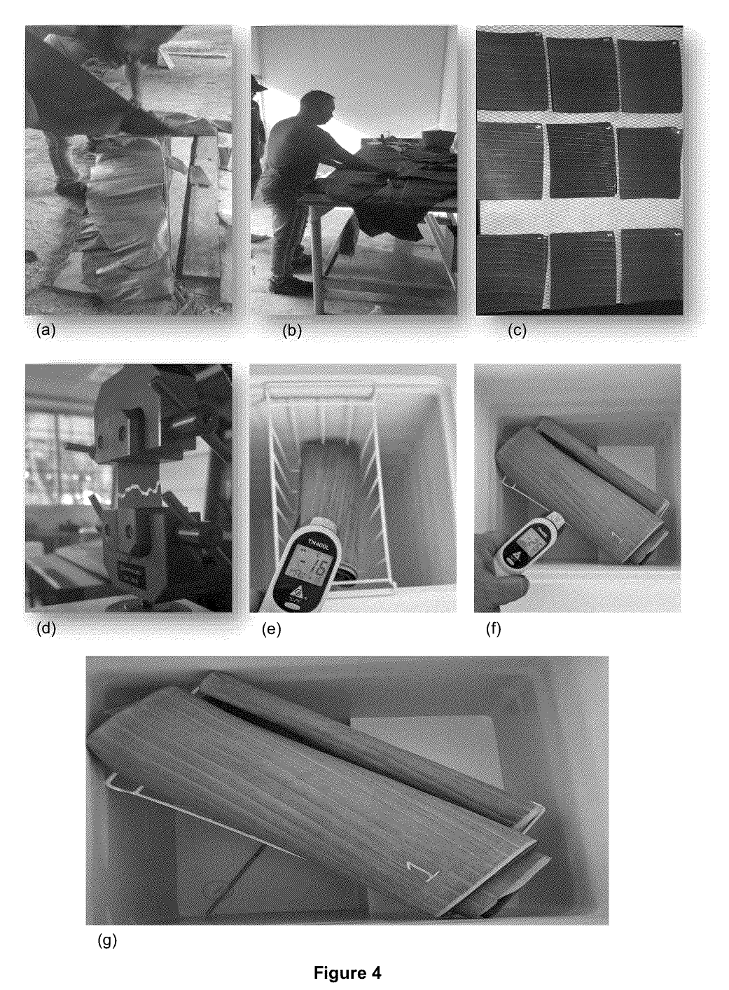

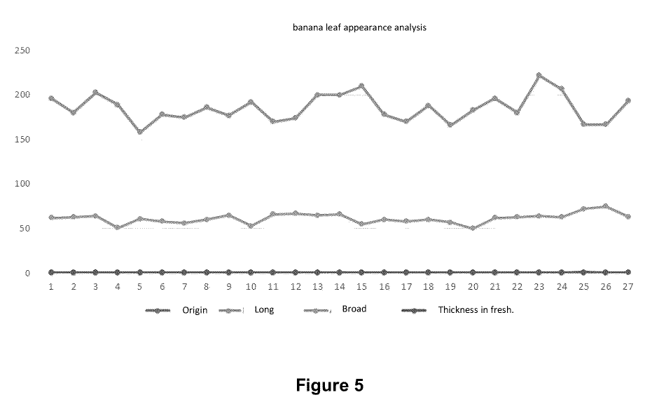

(b) Roll the banana leaf with the shortest section of the leaf as the axis of the roll (FIG. 3), to avoid mistreatment and/or damage to the banana leaf and to facilitate the transfer to a work station,

(c) Once the banana leaf is in the workstation, the banana leaf is unrolled to subject it to the process that consists of (FIG. 3):

I. Soar or lightly roast the banana leaf (FIG. 3c), by exposing the leaf to a temperature between 280° C. to 320° C. for 0.5 to 1.0 second.

In one embodiment, soaring consists of exposing or passing each leaf over a burning device that uses electrical energy or a liquid, gaseous or solid fuel, or any combination of these fuels, selected from natural gas, propane gas, infrared or of firewood. In one embodiment, the banana leaf is directly exposed to fire, in order to modify the texture and/or rigidity of the leaf, this process provides greater flexibility to the leaf, and with this it is possible to properly manipulate the leaf to provide a good wrap when preparing food. Likewise, the leaf presents a slight alteration in the color of the leaf, a change that is within the acceptable color range for the banana leaf.

II. Devein the banana leaf (FIG. 4a), Identify and extract the main vein or central vein, which corresponds to the thickest vein, which runs centrally along the leaf, to free the lateral sheets, so that the leaf has a uniform and clean appearance with the intention of improving the appearance and feel of the leaf, wherein deveining is done by trimming, folding and/or stretching the banana leaf to make a specific shape. This can be done with a pair of scissors, a scalpel, knife, razor, or any means of cutting where the first stage of deveining is to find the main vein, which is the thicker vein usually located along one side of the leaf and once it has been identified, a cutting device can be used to trim the part of the leaf containing the vein.

III. Cut the banana leaf (FIG. 4b-c) using a section that consists of having a diagonal incidence across the leaf to promote better absorption of sunlight and to help the banana leaf not lose important nutrients, this cut also reduces the area exposed of the leaf to the wind, which helps prevent desiccation and wind damage, in an alternative embodiment an edge cut is made to improve the appearance of the banana leaf by cutting a leaf strip of size uniform to create a decorative effect on the edge of the leaf.

IV. Weigh the banana leaf to measure the chlorophyll content in the leaves (FIG. 4d) and identify and evaluate the health status of the banana leaf and determine its nutritional value, this step is done by taking a sample of the banana leaf and weighing it to determine the weight of the chlorophyll in the leaf. Chlorophyll weight is used to determine the total nutrient content in the leaf, which is an important indicator of banana leaf health. This test is also used to evaluate the quality of foods produced from banana leaf.

V. Other methods of measuring chlorophyll in banana leaves consist of visually examining the leaf to determine the percentage of green areas. Leaf samples can also be taken for specific chemical tests to measure the chlorophyll content in the leaf. These tests can be useful in determining the quality of foods produced from the leaf. For its extraction and quantification, three methods are usually used: spectrophotometric, fluorometric and liquid chromatography where these consist of 1. The spectrophotometric method consists of measuring the absorption of light by chlorophyll in a solution. This measurement is made using a spectrophotometer, which measures the amount of light absorbed by a substance at different wavelengths of light. This measurement is used to determine the chlorophyll content in the leaf. 2. The fluorimetric method consists of measuring the fluorescence emitted by chlorophyll in a solution. This measurement is made using a fluorometer, which measures the amount of light emitted by a substance when exposed to light of a specific wavelength. This measurement is used to determine the chlorophyll content in the leaf. 3. The liquid chromatography method consists of separating the components of a solution using a chromatograph. This separation is used to identify and quantify solution components, including chlorophyll. This measurement is used to determine the chlorophyll content in the leaf.

Another equally useful method for measuring chlorophyll consists of the use of UV-visible spectrophotometry, which speeds up the analysis process and is highly efficient in its measurement. The UV-visible spectrophotometry method consists of measuring the absorption of ultraviolet and visible light by chlorophyll in a solution. This measurement is made using a spectrophotometer, which measures the amount of light absorbed by a substance at different wavelengths of light. This measurement is used to determine the chlorophyll content in the leaf. This technique is considered more effective than the other methods because it produces more accurate and reliable results.

VI. Disinfect the banana leaf by applying an appropriate disinfectant to eliminate pathogenic organisms from the leaf. The disinfectant can be a chemical product or a solution of soapy water or sodium hypochlorite. First, the blade should be washed with soap and water to remove any residue and dirt. Then, the leaf is immersed in the disinfectant for a period of between 5 and 10 minutes. After the specified time, the blade is removed from the disinfectant and rinsed with clean water for at least 60 seconds, to completely remove any disinfectant residue on the blade. Finally, the leaf should be air dried. This prevents pathogenic organisms from reproducing on the leaf surface. The advantages of subjecting a banana leaf to the disinfection process are the elimination of pathogens, the reduction of cross contamination and the preservation of food quality. In addition to those mentioned above, disinfection can be conducted using ultraviolet light or ionizing radiation, where established time and temperature parameters of 15 and 12 minutes respectively can be applied.

VII. Freeze the banana leaf (FIG. 4e-g) in a freezing apparatus or freezing chamber, where the leaves are arranged so that they have the largest contact surface. The banana leaves were arranged in a series of trays, trays or racks that allow a stream of freezing air to flow over the banana leaves. In one embodiment, the leaves were arranged in the form of rolls, in another embodiment the banana leaves were arranged in the form of extended sheets. The leaves are subjected to a temperature of −18° C. for at least 12 hours where the incidence of the current on both sides of the leaf has a particular relevance when freezing a leaf for food use since, if the air current is too strong, it can damage the leaf and lose its nutrients, in addition to causing a loss of flavor, quality and abnormal color. On the other hand, if the current is too weak, the leaf will not freeze properly, and its freshness will not be preserved.

In an equally preferred embodiment, the banana leaf is packed and subjected to the freezing process, for example, the banana leaves that come from the disinfection stage are introduced into special containers for vegetables of various capacities, as indicated. requires, and they are sealed; These containers are then placed in boxes of various capacities to be frozen. In one embodiment, under cleaning and disinfection conditions that ensure food safety, the banana leaves were placed in food grade bags with a capacity of 1 pound and then said bags were placed in boxes, which have a capacity of 12 or 24 pounds. The banana leaves packed in this way were subjected to freezing, by incubating them in freezing chambers at an average temperature of −18° C., for a time of between 22 to 24 hours.

VIII. Store banana leaves in an airtight container to maintain their freshness for longer and to protect them from damage during transportation and storage. Suitable containers include boxes, bags and boxes specially designed to protect leaves from moisture, dust, dirt, and mechanical damage. The most common material for sheet packaging is Kraft paper, although plastics, corrugated cardboard, and other materials can also be used. The packaging may also include a label or sticker to identify the contents and keep them safe.

Below are the results of the studies conducted on banana leaves without treatment and subjected to the process of the present invention:

The quality factors considered to be analyzed in the banana leaf will be those of visual appearance, considering the use of equipment and utensils for measuring appearance such as: texture, color, shape, and defects.

### Appearance

Appearance is the most important attribute in fresh and minimally processed foods, with primary aspects considered as size and uniformity of color, brightness, and absence of defects in contour or skin appearance. One of the main problems that arises when trying to preserve the banana leaf for prolonged periods of time is that significant changes occur in its appearance, such as color, which significantly detracts from the product. In terms of appearance, parameters such as shape, width, length, thickness, and cuts were analyzed.

TABLE 1
Data analyzed regarding appearance:

| | | | | Thickness in |
|---|---|---|---|---|
| Origin | Longe (cm) | Broad (cm) | Rip | fresh (mm) |
| IXHUATLÁN | 196 | 62 | 1 | 0.42 |
| IXHUATLÁN | 180 | 63 | 0 | 0.5 |
| IXHUATLÁN | 203 | 64 | 3 | 0.52 |
| IXHUATLÁN | 189 | 51 | 3 | 0.47 |
| IXHUATLÁN | 158 | 61 | 4 | 0.5 |
| IXHUATLÁN | 178 | 58 | 4 | 0.48 |
| IXHUATLÁN | 175 | 56 | 3 | 0.41 |
| IXHUATLÁN | 186 | 60 | 2 | 0.49 |
| IXHUATLÁN | 177 | 65 | 2 | 0.45 |
| IXHUATLÁN | 192 | 53 | 1 | 0.47 |
| IXHUATLÁN | 170 | 66 | 1 | 0.57 |
| IXHUATLÁN | 174 | 67 | 1 | 0.55 |
| IXHUATLÁN | 200 | 65 | 1 | 0.59 |
| IXHUATLÁN | 200 | 66 | 5 | 0.62 |
| IXHUATLÁN | 210 | 55 | 6 | 0.52 |
| IXHUATLÁN | 178 | 60 | 3 | 0.49 |
| IXHUATLÁN | 170 | 58 | 4 | 0.5 |
| IXHUATLÁN | 188 | 60 | 0 | 0.5 |
| IXHUATLÁN | 166 | 57 | 0 | 0.49 |
| IXHUATLÁN | 183 | 50 | 0 | 0.4 |
| IXHUATLÁN | 196 | 62 | 1 | 0.42 |
| IXHUATLÁN | 180 | 63 | 0 | 0.5 |
| IXHUATLÁN | 222 | 64 | 1 | 0.53 |
| IXHUATLÁN | 207 | 63 | 1 | 0.38 |
| IXHUATLÁN | 167 | 72 | 0 | 0.81 |
| IXHUATLÁN | 167 | 75 | 0 | 0.72 |
| Averages | 193.3 | 63.3 | 1.51 | 0.5 |

The results obtained by analyzing the quality characteristics of the banana leaf are the following: In the factors related to appearance, one of the greatest details that was appreciated were the breaks in the leaves, a crucial factor since it determines the quality of the banana leaf. and it conditions the useful area of the product, which also impacts the number of leaves or fragments that will be used to complete the final weight of a pound which will be packaged and frozen; Therefore, I analyze that on average harvested banana leaves have 1 to 2 cuts at the ends, so the way in which the leaf is cut in the field is important.

The results regarding the lake of leaves obtained an average of 193.3 cm in length, which is also a crucial point, since it is a function of the growth, the degree of maturation of the leaf since it can provide more or less texture. The average width of the two sheets that make up the leaf was 63.3 cm. Likewise, the average thickness obtained in the analyzes of the leaves coming from the municipality of Ixhuatlan del café, Veracruz, was 0.52 cm. These characteristics are important since they are the basis of the analyzes that allowed defining the characteristics of the processes established in this banana leaf freezing process.

### Texture.

The texture of fruits and vegetables is frequently considered in terms of firmness, crunch, juiciness, and hardness (attributed to the fibrosity of the plant tissue), where firm or crisp tissue is generally desired in fresh and minimally processed fruits and vegetables.

Texture is an especially important quality indicator for consumption and preparation, in addition to indicating stress effects during transportation. However, the development of fiber in the stems, as in asparagus, or hardening caused by dehydration in fresh products is unacceptable. The loss in juiciness results in dry and hard structures that cause adverse effects on quality (Emboscada and Huber, 2009). For the banana leaf terms, the leaf processing was analyzed after having been subjected to freezing treatments and the texture was evaluated in the hardness parameter attributed to the fibrosity of the plant tissue.

Texture analysis allows measuring the structural and mechanical properties of the banana leaf, and is conducted with Texturometer; KOMATSU 50N, according to the equipment layout and in the authorized laboratory.

The main indicators to obtain will be: MAXIMUM STRENGTH and CUTTING STRENGTH.

The maximum stress that a material can withstand under tension before its cross-section contracts significantly is called ultimate stress OR shear force. Breaking stress is defined as a stress that is measured in units of force per unit area. For some non-homogeneous materials, it is indicated as a force or a force per unit thickness. In the international system, the unit is the pascal (Pa) (or a multiple thereof, often the megapascal (MPa), using the prefix Mega); or, equivalent to Pascal, Newton per square meter (N/m²).

The breaking stress is usually obtained by performing a tensile test and recording the stress as a function of strain (or elongation); The highest point on the stress-strain curve is the failure stress. It is an intensive property; Therefore, its value does not depend on the size of the sample, but on factors, such as preparation, the presence or absence of surface defects, and the temperature of the environment and the material.

### Color

Colorimetry is a widely used non-destructive physical method to determine the color of a sample. To measure color, a calibrated instrument called colorimeter, or a spectrophotometer is used, which also allows obtaining the spectral curve. The function of the colorimeter, in the case of a plant product, is to quantitatively describe the coloration of the epidermis. There are different models proposed (Carreño et al., 1995; Lana et al., 2006; Mendoza et al., 2006) to facilitate the selection of colored objects in a standard way.

Regarding the color of the banana leaf, different fresh banana leaves were evaluated, as well as after they were subjected to freezing processes and the results were analyzed.

TABLE 2
The results obtained with respect to color and texture characteristics
of fresh banana leaves are presented below.

| | Longe | Broad | | Max | Break |
|---|---|---|---|---|---|
| Origin | (cm) | (cm) | Rip | Stress | force |
| IXHUATLÁN | 14.76 | −3.92 | 7.75 | 0.89 | 8.96 |
| IXHUATLÁN | 19.4 | −4.99 | 9.24 | 2.22 | 22.32 |
| IXHUATLÁN | 19.58 | −4.32 | 8.38 | 2.72 | 27.31 |
| IXHUATLÁN | 18.43 | −4.65 | 10.27 | 1.43 | 14.36 |
| IXHUATLÁN | 16.93 | −2.53 | 5.46 | 1.59 | 16 |
| IXHUATLÁN | 17.65 | −3.63 | 7.18 | 1.7 | 17.1 |
| IXHUATLÁN | 17.56 | −4.61 | 9.34 | 0.72 | 7.28 |
| IXHUATLÁN | 16.87 | −3.06 | 6.26 | 1.8 | 18.09 |
| IXHUATLÁN | 22.04 | −6.01 | 13.68 | 0.99 | 9.96 |
| IXHUATLÁN | 20.07 | −4.5 | 12.35 | 0.91 | 9.22 |
| IXHUATLÁN | 16.75 | −3.39 | 6.01 | 0.86 | 8.72 |
| IXHUATLÁN | 21.04 | −5.42 | 9.89 | 0.99 | 9.94 |
| IXHUATLÁN | 15.12 | −4.5 | 8.94 | 0.91 | 9.22 |
| IXHUATLÁN | 19.67 | −5.47 | 10.29 | 0.86 | 8.72 |
| IXHUATLÁN | 14.27 | −3.57 | 6.93 | 0.99 | 9.94 |
| IXHUATLÁN | 13.72 | −3.42 | 6.58 | 1.32 | 13.26 |
| IXHUATLÁN | 14.76 | −5.06 | 10.11 | 0.12 | 1.21 |
| IXHUATLÁN | 17.31 | −4.78 | 9.23 | 1.82 | 18.34 |
| IXHUATLÁN | 16.18 | −4.75 | 9.18 | 1.28 | 12.86 |
| IXHUATLÁN | 17.14 | −3.93 | 8.03 | 2.02 | 20.3 |
| IXHUATLÁN | 18.98 | −4.92 | 9.27 | 0.66 | 6.13 |
| IXHUATLÁN | 23.81 | −6 | 12.78 | 1.5 | 13.83 |
| IXHUATLÁN | 13.72 | −4.37 | 8.19 | 0.89 | 9.88 |
| IXHUATLÁN | 13.46 | −4.65 | 9.6 | 0.44 | 4.91 |
| IXHUATLÁN | 13.57 | −4.34 | 8.99 | 0.63 | 6.98 |
| IXHUATLÁN | 11.09 | −2.53 | 4.64 | 1.19 | 13.15 |
| Average | 19.7 | −3.01 | 6.38 | 1.5 | 14.9 |

TABLE 3
The results obtained with respect to color and texture characteristics
of frozen banana leaves are presented below.

| | | | | Max | Break |
|---|---|---|---|---|---|
| Origin | Longe (cm) | Broad (cm) | Rip | Stress | force |
| IXHUATLÁN | 22.42 | −2.84 | 5.14 | 1.98 | 18.02 |
| IXHUATLÁN | 22.8 | −2.35 | 5.02 | 0.48 | 4.47 |
| IXHUATLÁN | 21.02 | −4.75 | 9.7 | 3.63 | 34.52 |
| IXHUATLÁN | 21.1 | −4.08 | 6.57 | 2.067 | 19.64 |
| IXHUATLÁN | 21.52 | −3.68 | 6.67 | 3.86 | 37.2 |
| IXHUATLÁN | 22.69 | −4.34 | 8.18 | 4.05 | 37.08 |
| IXHUATLÁN | 24.47 | −3.41 | 8.89 | 4.02 | 36.2 |
| IXHUATLÁN | 21.13 | −3.04 | 7.08 | 2.2 | 19.73 |
| IXHUATLÁN | 22.84 | −1.7 | 5.55 | 2.23 | 20.11 |
| IXHUATLÁN | 22 | −3.62 | 6.11 | 2.21 | 19.92 |
| IXHUATLÁN | 20 | −2.81 | 5.52 | 0.96 | 10.6 |
| IXHUATLÁN | 20.32 | −2.83 | 4.74 | 1.17 | 12.88 |
| IXHUATLÁN | 21.12 | −3.65 | 6.16 | 0.5 | 5.56 |
| IXHUATLÁN | 20.06 | −3.82 | 6.93 | 0.67 | 1.84 |
| IXHUATLÁN | 21.21 | −3.48 | 5.77 | 0.79 | 8.07 |
| IXHUATLÁN | 20.32 | −2.83 | 4.45 | 0.61 | 6.9 |
| IXHUATLÁN | 24.93 | −5.15 | 10.66 | 1.14 | 10.56 |
| IXHUATLÁN | 18.85 | −2.56 | 4.01 | 0.73 | 6.77 |
| IXHUATLÁN | 18.56 | −2.59 | 4.68 | 2.79 | 29.2 |
| IXHUATLÁN | 20.41 | −3.27 | 6.17 | 0.87 | 9.58 |
| IXHUATLÁN | 18.65 | −2.42 | 4.71 | 0.72 | 8.52 |
| IXHUATLÁN | 16.83 | −3.02 | 6.22 | 1.3 | 14.98 |
| IXHUATLÁN | 19.52 | −3.1 | 6.59 | 0.81 | 8.99 |
| IXHUATLÁN | 20.26 | −3.21 | 5.52 | 1.62 | 17.9 |
| IXHUATLÁN | 22.28 | −4.29 | 11.35 | 3.23 | 35.6 |
| IXHUATLÁN | 22.52 | −4.09 | 11.5 | 1.26 | 13.95 |
| IXHUATLÁN | 20.35 | −3.31 | 7.77 | 2.61 | 28.79 |
| IXHUATLÁN | 21.18 | −4.22 | 8.83 | 1.3 | 14.3 |
| Average | 21.05 | −3.37 | 6.80 | 1.78 | 17.57 |

The data obtained and analyzed from the banana leaf comes from applying the aforementioned treatments, the banana leaf, harvested, selected, being roasted at a temperature of 280° C. for 1 second and then letting it rest until an ambient temperature of 24° C., and then subjecting it to the freezing procedure for 24 hours at −18° C., the following results were obtained, which allowed defining the texture characteristics.

According to the results obtained for the initial characteristics of color and texture, they show that in the Max Stress parameter, which indicates how strong or resistant the banana leaf is, a value of 1.5 N was obtained (table 2) and after the treatments with the process of the present invention, a value of 1.7 N was obtained (table 3), so the effect of the processing treatments provides the banana leaf product with greater resistance to breakage, without altering its flexibility significantly, that is, with these treatment characteristics, the banana leaf has excellent resistance and at the same time has the appropriate malleability or flexibility to be used in the food field. Demonstrating that the selected parameters such as roasting time and freezing time and freezing temperature are ideal for preserving texture characteristics.

The method used to analyze the color and the color result, as an effect of roasting and freezing, was by the CIE L*A*B* method.

The L*a*b* color space, also referred to as CIELAB, is currently one of the most popular and consistent color spaces used to evaluate the color of an object. This color space is widely used because it perfectly correlates numerical color values consistently with human visual perception.

L*=luminosity

a*=red/green coordinates (+a indicates red, −a indicates green)

b*=yellow/blue coordinates (+b indicates yellow, −b indicates blue)

The results obtained on the initial color measured with a colorimeter on the CIE Lab scale, in the fresh banana daughters gave the following values, L*: 19.7, a*: −3.01 and b*: 6.38.

For its part, for the banana leaves frozen with the process of the claimed invention, the averages obtained for the L*a*b* values were the following:

L*: 21.05, a*: −3.37 and b*: 6.8.

The representation of these colors on the visual scale is presented below.

From these results it could be observed that the effect of the treatments on color was mainly a variation in the L measurement; (L*=luminosity), so the color characteristics suffered minimal variations with respect to the luminosity in the product. That is, the color of the banana leaf obtained by the process of the described invention is characteristic and is within the range of acceptable coloration for the commercial banana leaf,

As is evident, with the process of the present invention it has been possible to obtain banana leaves with excellent appearance, characteristic and uniform color, resistance and flexibility that can be stored for long periods of time without suffering significant alterations in said parameters, which It allows the user to have the banana leaf at any time of the year.

### Storage Tests

The banana leaves obtained by the present invention were stored frozen, after several months they were subjected to various studies to determine their appearance: A sample of banana leaves prepared as previously described was analyzed, and after 3 and 6 months During storage, it was found that the color of the banana leaf remained without perceptible changes to the human eye, this is with the naked eye; However, through colorimetric analyzes a color difference is observed, which is in the range between sRGB: 49, 52, 40 after freezing and sRGB: 41, 42, 36 after storage. Similarly, stored banana leaves were evaluated, finding that from the physical examination no alteration was observed in the appearance or texture of the leaves, nor was contamination with microorganisms observed; The leaves were thawed and subjected to a test for food preparation, for which freshly frozen banana leaves and banana leaves that were kept in storage for 3 and 6 months were used, finding that no difference was seen in the maneuverability, flexibility, appearance and color of the leaves in the preparation of tamales, even more so after cooking, no defects or deterioration of the frozen and/or stored leaves were observed.

1. A process to preserve musa spp leaves comprising the following steps:
(a) roasting banana leaves, by exposing the leaf to a temperature between 280° C. to 320° C. for 0.5 to 1.0 second;
(b) deveining the banana leaf by identifying a main vein of the banana leaf and making a cut, on both sides of the main vein and along a length until blades of the banana leaf are freed;
(c) eliminating foreign matter and/or microorganisms and parts of the banana leaf that present any undesirable defects in texture, color, or deformations, and then washing the leaves with a soapy water solution, subsequently the leaf is immersed in a disinfectant for a period of between 5 and 10 minutes;
(d) cutting and weighing the banana leaf into fragments or section of a desired size; and weigh to obtain a desired weight amount;
(e) packaging the banana leaf in barrier media to contain them; and
(f) freezing the packaged banana leaf at an average temperature of −18° C. until use.

2. The process for preserving musa spp banana leaves according to claim 1, further comprising the step of searing by exposing the banana leaf to a burning device that uses electrical energy or a liquid fuel, gaseous or solid, selected from natural gas, propane, infrared or wood gas, or any combination of these.

3. The process for preserving musa spp banana leaves according to claim 1, wherein the deveining step is conducted with machinery or manually; with a cutting device, such as scissors, scalpel, knife, razor, or any cutting device.

4. The process for preserving musa spp banana leaves in accordance with claim 1, wherein the freezing step includes applying a current of air to create a flow that runs over the surface of both sides of the leaves, at a temperature below −18° C. for a period of between 12 hours to 24 hours.

5. The process for preserving musa spp banana leaves according to claim 1, wherein in the freezing step, the banana leaves are packed in a plastic bag with a capacity of 1 pound and, at the same time the bag is packet in boxes with a capacity of between 12 and 24 pounds.
